(19) United States
(12) Patent Application Publication
(10) Pub. No.: US 2003/0115870 A1
(43) Pub. Date: Jun. 26, 2003

(54) Exhaust-gas turbocharger in an internal combustion engine

(76) Inventors: Helmut Finger, Leinfelden-Echterdingen (DE); Peter Fledersbacher, Stuttgart (DE); Roger Martin, Othmarsingen (CH); Siegfried Sumser, Stuttgart (DE)

Correspondence Address: KENYON & KENYON, ONE BROADWAY, NEW YORK, NY, 10004, US

(21) Appl. No.: 10/188,382

(22) Filed: Jul. 2, 2002

(30) Foreign Application Priority Data
Jul. 11, 2001 (DE) 101 33 669.1

(51) Int. Cl. F02D 23/00

(52) U.S. Cl. 60/602

(57) ABSTRACT

An exhaust-gas turbocharger in an internal combustion engine has a turbine and a compressor which is driven by the turbine and contains, in a compressor flow duct, a compressor impeller. A bypass to the compressor impeller communicates with the inflow duct via a first flow opening and, via a second flow opening, communicates with the compressor outflow region downstream of the outlet edge of the compressor impeller. A shutoff element which may be adjusted between a closing position and an opening position is provided in the bypass for the purpose of variably setting the effective flow cross-section of the bypass. The adjustable shutoff element is arranged in the second flow opening to the compressor outflow region.

### FIELD OF THE INVENTION

The present invention relates to an exhaust-gas turbocharger in an internal combustion engine.

### BACKGROUND INFORMATION

The behavior of compressors of exhaust-gas turbochargers can be described by a map in which the compression ratio is illustrated over the compressor as a function of the mass flow which has passed through the compressor. The compressor operation is restricted in the small mass-flow direction by a surge limit and in the large mass-flow direction by a filling limit. During compressor operation in the vicinity of the surge limit, at the blades of the compressor impeller there are locally restricted zones of separation which may have the consequence of the flow pulsating with a periodic change in the direction of flow. On the other hand, the filling limit is reached at high mass flow rates in the upper rotational-speed range of the engine. The filling limit arises by virtue of the fact that at great flow rates at the compressor-impeller inlet—which, as a rule, is the narrowest cross-section in the compressor—the speed of sound is obtained and thus the flow rate cannot be increased further.

In order to enlarge the operative range of compressors, what are referred to as map-stabilizing measures can be provided, the measures displacing both the surge limit and the filling limit in favor of an enlarged operative range. Thus, for example, the German Published Patent Application No. 42 13 047 describes the provision parallel to the compressor inflow duct in the compressor housing of a bypass which spans the compressor-impeller inlet edge. When the compressor is operated in the vicinity of the surge limit, the bypass allows a partial mass flow to recirculate counter to the main direction of flow in the inflow duct. The recycled partial mass flow is re-supplied to the main mass flow via the bypass and conveyed again into the compressor. The surge limit is thereby displaced in the direction of relatively small mass flows.

In addition, the map-stabilizing measure results in the filling limit being displaced in favor of relatively large mass flows. The additional bypass enlarges the entire cross-section over which the induction air can be supplied to the compressor, as a result of which overall larger volumetric flows can be conveyed.

A map-stabilizing measure in the form of a bypass spanning the compressor-impeller inlet edge is also described in German Published Patent Application No. 198 23 247, the bypass of which connects the compressor inflow duct upstream of the compressor-impeller inlet edge to a spiral duct on the outlet side of the compressor, an adjustable directing lattice being arranged in the flow opening of the bypass to the compressor inflow duct, the directing lattice causing additional swelling of the recycled partial mass flow when it re-enters the flow duct towards the main flow. The effective flow cross-section of the bypass can be set variably via the directing lattice. It is possible, in particular, to shut off the bypass between the surge limit and the filling limit in the main operating range of the compressor, with the result that partial mass flows cannot pass through the bypass, and the entire mass flow is directed through the flow duct of the compressor. This makes it possible to avoid disturbing eddying of the flow in the flow duct and to improve the efficiency.

It is an object of the present invention to provide a simple configuration to provide an exhaust-gas turbocharger with a compressor having an enlarged map.

### SUMMARY

The above and other beneficial objects of the present invention are achieved by providing an exhaust-gas turbocharger as described herein.

The adjustable shutoff element, via which the bypass may be closed or opened, sits in the flow opening of the bypass to the compressor outflow region downstream of the compressor impeller. In comparison to previously conventional shutoff elements in the flow opening to the compressor inflow duct, the position of the shutoff element in the flow opening to the compressor outflow region, this being, e.g., a spiral duct of the compressor, may provide the advantage of being at a relatively great distance from the inflow duct and from the compressor impeller, which may signify a gain in space for the compressor impeller and may also considerably improve the ease of installation, since only one installation hole may have to be made in the compressor housing in order to accommodate the shutoff element.

The shutoff element is configured, e.g., as a shutoff valve which may take up two discrete switching positions—an opening position or closing position. The configuration as a shutoff valve which may be adjusted between two discrete positions is distinguished by particular simplicity, the switching states of “bypass closed” and “bypass open” being sufficient in order to realize an expanded map for the compressor. The bypass may be opened only if the compressor operates in the vicinity of the surge limit in order to enable a specific recirculation of a partial mass flow, as a result of which the surge limit is displaced in favor of relatively small mass flows. In contrast, in the main operating range of the compressor between the surge limit and filling limit, the shutoff element is adjusted into a closing position and the bypass is shut off with the result that partial mass flows may not pass through the bypass, and the entire mass flow is conducted through the flow duct of the compressor.

If the second flow opening is not arranged downstream of the compressor-impeller outlet edge, but rather still in the region of the compressor impeller, in the case of the compressor being operated in the vicinity of the filling limit, it is possible to open the shutoff element in order to enlarge the entire cross-section in the direction of flow toward the compressor impeller and to supply the compressor impeller with an additional partial mass flow via the bypass in the same direction of flow as the main flow.

If, in contrast, the second flow opening of the bypass to the compressor outflow region is arranged downstream of the compressor-impeller outlet edge, as is the case, in particular, when the bypass is connected to the spiral duct of the compressor, then in order to avoid a loss in pressure during operation in the vicinity of the filling limit, the shutoff element may be set into a shutoff position.

In one example embodiment, the shutoff element, which is configured as a shutoff valve, may be adjusted in a translatory manner between an opening and closing position, the adjusting direction of the shutoff valve which may extend parallel to the axis of the exhaust-gas turbocharger.

The shutoff element may be adjusted mechanically between a closing and opening position. As adjusting device, a pneumatic adjusting element may be provided, and the element may be connected to a compressed-air reservoir which supplies the adjustment energy for the pneumatic adjusting element and the shutoff element in the bypass. A pneumatic valve which is to be set via adjusting signals from a regulating and control unit and controls the compressed-air supply to the pneumatic adjusting element may be arranged in the connecting path between the compressed-air reservoir and pneumatic adjusting element.

As an alternative to an adjusting element which may be adjusted pneumatically, electric or electromagnetic or hydraulic adjusting elements are also possible.

A collecting space having an expanded cross-section may be provided in the bypass and enables an optimum flow against the directing lattice connected downstream. A directing lattice, in particular an adjustable directing lattice, may be arranged in the region of the first flow opening, via which the bypass is connected to the compressor inflow duct, it being possible for the directing lattice to be used to have a positive effect on the swelling of the flow of the recycled partial mass flow during operation in the region of the surge limit.

The first flow opening may open in the region downstream of the compressor-impeller inlet edge and upstream of the compressor-impeller outlet edge into the compressor inflow duct and may therefore be situated axially in the compressor-impeller region.

### BRIEF DESCRIPTION OF THE DRAWINGS

FIG. 1 is a schematic cross-sectional view through an exhaust-gas turbocharger having an exhaust-gas turbine with variable turbine geometry and a compressor having a map-stabilizing measure, the exhaust-gas turbocharger being assigned to an internal combustion engine.

FIG. 2 illustrates a compressor map having characteristic curves for the compression ratio over the compressor as a function of the reduced mass flow.

### DETAILED DESCRIPTION

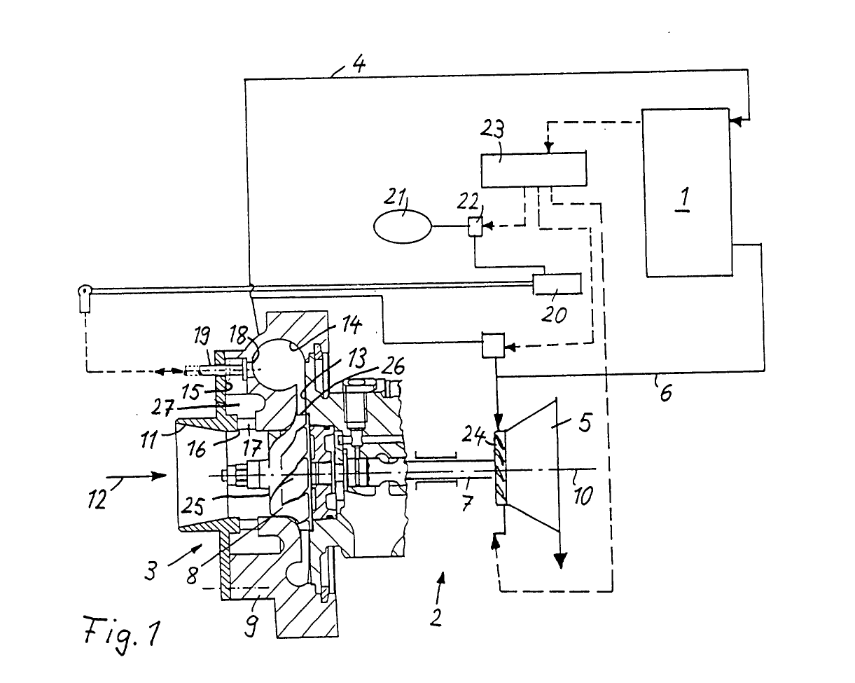

The internal combustion engine 1 illustrated in FIG. 1, for example a spark-ignition combustion engine or a diesel internal combustion engine, contains an exhaust-gas turbocharger 2 which has a compressor 3 in the induction tract 4 and an exhaust-gas turbine 5 in the exhaust-gas section 6 of the internal combustion engine, the exhaust-gas turbine 5 being driven by the exhaust gases, which are under pressure, and the movement of the turbine wheel being transmitted via a shaft 7 to the compressor impeller 8 which sucks in combustion air, which is under atmospheric pressure, and compresses it to an increased charging pressure. Provided in the housing 9 of the compressor 3 is an inflow duct 11 which is arranged coaxially with the axis of rotation 10 of the charger and via which ambient air is sucked in in the main direction of flow 12 and supplied to the compressor impeller 8. After the compression, the charge air is conducted radially via a diffuser 13 into a spiral duct 14 in the compressor housing 9, from which the charge air is guided into the induction tract 4 and on into the air intake of the internal combustion engine 1.

A bypass 15 for connecting the inflow duct 11 upstream of the compressor impeller 8 to the spiral duct 14 downstream of the compressor impeller is provided in the compressor housing 9. The bypass 15 communicates with the inflow duct 11 via a first flow opening 16 in the radial outer wall. A directing lattice 17, which is configured, e.g., in a manner such that it may be adjusted, may be provided in the region of the first flow opening 16. The first flow opening 16 may be arranged axially downstream of the compressor-impeller inlet edge 25, but upstream of the compressor-impeller outlet edge 26, in the transition to the diffuser 13. However, the first flow opening 16 may also be arranged upstream of the compressor-impeller inlet edge 25.

In the region of an opposite end, the bypass 15 communicates with the spiral duct 14 via a second flow opening 18, the second flow opening 18 opening approximately parallel to the axis of rotation 10 into the spiral duct 14. The second flow opening 18 may be opened and closed via a shutoff element which is configured as a shutoff valve 19 and may be adjusted axially in a translatory manner between a closing position and an opening position, the bypass being shut off in the closing position and the bypass being opened in the opening position. The adjusting direction of the shutoff valve 19 is, e.g., parallel to the axis of rotation 10 of the charger. In an example embodiment, the shutoff valve 19 may only take up the two discrete positions of opening position and closing position. However, in an alternative example embodiment, intermediate positions are also possible, in order to be able to variably and continuously control the flow reflux of the charge air, which is under increased charging pressure, from the spiral duct 14 into the inflow duct 11.

The shutoff element in the bypass 15 may be adjusted between a closing and opening position by an adjusting element. In this example embodiment, the adjusting element is configured as a pneumatic adjusting element 20 which may be actuated pneumatically and is connected to a compressed-air reservoir 21, a pneumatic valve 22 which may be set being arranged in the connecting path between the compressed-air reservoir 21 and pneumatic adjusting element 20, which pneumatic valve may be set via adjusting signals from a regulating and control unit 23 as a function of state and operating variables of the internal combustion engine 1, the exhaust-gas turbocharger 2 and, if appropriate, further units which are assigned to the internal combustion engine. The regulating and control unit 23 may also be used to set a variable turbine geometry 24 for the exhaust-gas turbine 5, via which the effective flow cross-section in the exhaust-gas turbine may be set in a variable manner.

A collecting space 27 having an expanded cross-section is formed in the bypass 15 and is positioned directly adjacent to the first flow opening 16 via which the bypass communicates with the inflow duct 11. The collecting space 27 has a relatively large volume which, in particular, exceeds the volume of the remaining sections of the bypass. The volume of the collecting space 27 improves the conditions for the directing lattice 17 in terms of the flow against it.

The narrowest flow cross-section of the bypass 15 is arranged in the region of the flow opening 16 into which the directing lattice 17 is inserted.

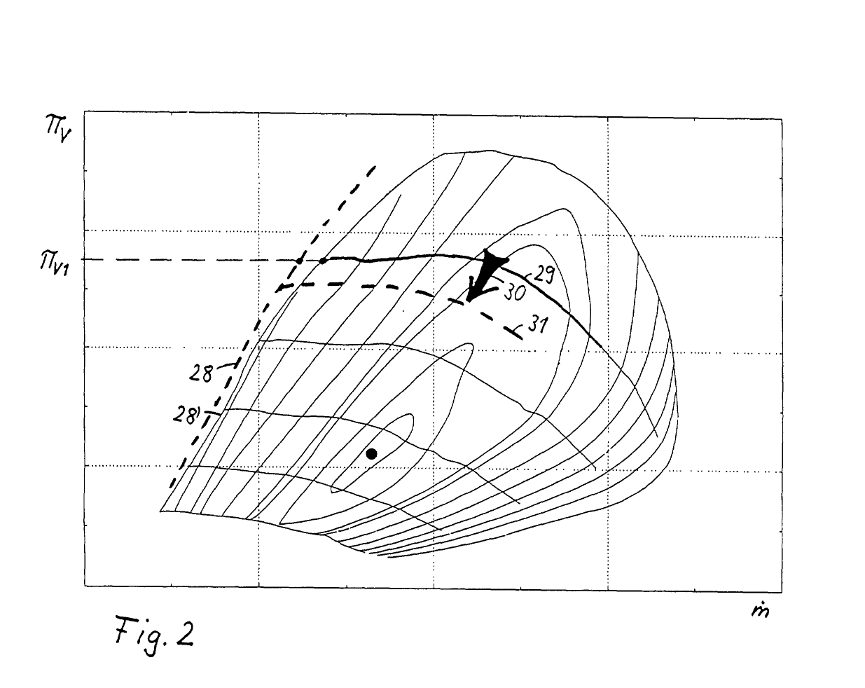

FIG. 2 illustrates a compressor map having different characteristic curves for the compression ratio Πᵥ as a function of a reduced reference mass flow \dot{m}, the compression ratio Πᵥ expressing the ratio of the charging pressure directly downstream of the compressor to the atmospheric pressure upstream of the compressor, and the reduced reference mass flow \dot{m} taking into consideration a reference pressure and reference temperature under normal conditions. As illustrated, a lower surge limit 28, which restricts the map towards low mass flows, is plotted with a dashed line. In comparison to a solid line 28′, the dashed line 28 has already been reduced in favor of a smaller mass flow, which is achieved by the activation of the map-stabilizing measure by opening the bypass. Activation of the map-stabilizing measure causes the compression ratio Πᵥ to be reduced according to the arrow 30 from the solid line 29 to the dashed line 31 with conditions otherwise remaining the same due to the partial equalization of the pressure between the spiral duct and inflow duct. In order to reach a predetermined compression ratio Πnᵥ, the rotational speed of the compressor required for this rises. This also has a positive effect on the efficiency of the turbine, since the latter operates at favorable running speeds. At low rotational speeds of the engine, in particular, the effect is therefore not only a desired displacement of the surge limit 28 in favor of smaller mass flows, but also an improvement in the overall efficiency of the charger.

In order, starting from an operating point at low load, to increase the charging pressure as rapidly as possible, an increased starting rotational speed of the exhaust-gas turbocharger at the beginning of the load-bearing flow is possible. Such an increase in the rotational speed of the charger may be achieved by opening the bypass, since—as described above—a higher rotational speed of the compressor is required for a certain value of the charging pressure and of the compression ratio Πᵥ with the bypass opened. The opened connection between the inflow duct and spiral duct may also provide an additional advantage in the event of acceleration at full load, in which the compressor is operated in the vicinity of the surge limit and is started along the surge limit 28, and a subsequent, abrupt removal of load, as a result of which there is the risk of compressor surges in the case of conventional compressors, since in the process the mass flow is rapidly reduced, but the rotational speed of the compressor only drops comparatively slowly due to inertia. In these situations, the risk of compressor surges may be reduced by reducing the surge limit.

The setting of the shutoff element in the bypass between the inflow duct and in the compressor outflow region may also be used for regulating the load on the internal combustion engine, in particular a spark-ignition combustion engine, and may entirely or partially replace the conventional throttle-valve regulation, in particular in combination with the an arrangement configured to regulate the variable turbine geometry of the exhaust-gas turbocharger.

What is claimed is:

1. An exhaust gas turbocharger in an internal combustion engine, comprising:
an exhaust-gas turbine;
a compressor driven by the exhaust-gas turbine and including a compressor impeller arranged in a compressor inflow duct and a bypass to the compressor impeller, the bypass configured to communicate with the compressor inflow duct via a first flow opening and configured to communicate by a second flow opening with a compressor outflow region downstream of a compressor-impeller outlet edge; and
a shutoff element configured to be adjusted between a closing position and an opening position provided in the bypass to variably set an effective flow cross-section of the bypass, the adjustable shutoff element arranged in the second flow opening to the compressor outflow region.

2. The exhaust-gas turbocharger according to claim 1, wherein the compressor outflow region, with which the bypass is configured to communicate via the second flow opening, includes a spiral duct of the compressor.

3. The exhaust-gas turbocharger according to claim 1, wherein the shutoff element is adjustable between the opening and closing position via a pneumatic adjusting element.

4. The exhaust-gas turbocharger according to claim 3, wherein the pneumatic adjusting element is connected to a compressed-air reservoir.

5. The exhaust-gas turbocharger according to claim 4, further comprising a pneumatic valve configured to be set via adjusting signals from a regulating and control unit arranged in a connecting path between the compressed-air reservoir and the pneumatic adjusting element.

6. The exhaust-gas turbocharger according to claim 1, wherein the shutoff element includes a shutoff valve arranged to be closed in a translatory manner between the opening position and the closing position, an adjusting direction of the shutoff valve extending parallel to an axis of rotation of the exhaust-gas turbocharger.

7. The exhaust-gas turbocharger according to claim 1, further comprising a collecting space including an expanded cross-section arranged in the bypass.

8. The exhaust-gas turbocharger according to claim 7, wherein the collecting space is arranged in the bypass directly in a region of the first flow opening which communicates with the compressor inflow duct.

9. The exhaust-gas turbocharger according to claim 7, wherein a volume of the collecting space exceeds a volume of remaining sections of the bypass.

10. The exhaust-gas turbocharger according to claim 1, wherein the first flow opening in the bypass is configured to communicate with the compressor inflow duct in the region downstream of the compressor-impeller inlet edge and upstream of the compressor-impeller outlet edge.

11. The exhaust-gas turbocharger according to claim 1, further comprising an adjustable directing lattice arranged in the first flow opening to the compressor inflow duct.
